(19) United States
(12) Patent Application Publication
(10) Pub. No.: US 2016/0004023 A1
(43) Pub. Date: Jan. 7, 2016

(54) HIGH TEMPERATURE RADIO FREQUENCY RESISTANT FIBER OPTIC CABLE

(71) Applicant: Brian HERBST, (US)

(72) Inventors: Brian HERBST, Easley, SC (US); Michael PLASCAK, Greenville, SC (US); Brett VILLIGER, Simpsonville, SC (US); Brad HENDRIX, Campobello, SC (US); Joe CIGNARALE, Greer, SC (US)

(73) Assignee: AFL TELECOMMUNICATIONS LLC, Duncan, SC (US)

(21) Appl. No.: 14/765,163

(22) PCT Filed: Feb. 3, 2014
(86) PCT No.: PCT/US14/14420

§ 371 Date: Jul. 31, 2015

Related U.S. Application Data
(60) Provisional application No. 61/759,438, filed on Feb. 1, 2013.

(51) Int. Cl. G02B 6/44; G02B 6/02

(52) U.S. Cl. CPC G02B 6/443; G02B 6/02395

(57) ABSTRACT

A high temperature radio frequency (RF) resistant fiber optic cable is provided. The cable includes an innermost fiber layer, a first coating layer covering the innermost fiber, a second coating layer covering the first coating layer, and a third coating layer covering the second coating layer. The composition and thickness of the coating layers can be changed to achieve the desired temperature resistance and characteristics.

### CROSS-REFERENCE TO RELATED APPLICATIONS

This application is based upon and claims the benefit of priority from U.S. Provisional Application No. 61/759,438, filed Feb. 1, 2013 in the United States Patent and Trademark Office, the disclosures of which are incorporated herein in its entirety by reference.

### BACKGROUND

1. Field

The invention is related to a fiber optic cable, and more particularly to a high temperature radio frequency (RF) resistant cable.

2. Related Art

The background information provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

RF energy can be used for a variety of applications—some of which involves heating a media. There is a desire to monitor these environments to see what the temperature, strain or acoustics are in these areas. One of the ways these attributes can be monitored is the use of fiber optic sensing. However, the conventional fiber optic cables face a challenge. They are typically rated to <85° C. and are designed in such a way that, although dielectric in construction, elements within them such as carbon black and metallic elements for colorants, absorb the RF energy and generate heat within the cable making the sensor (the optical fiber) readings erroneous. In addition, conventional fiber optic cables comprise air pockets within the structure diminishing the thermal sensitivity (ability to sense temperature changes quickly) and acoustic sensitivity.

Some conventional optical fiber has a high temperature coating of polyimide (˜15 micron). While such a coating does increase the temperature resistance of the optical fiber, due to the hard coating material, it typically results in a high amount of optical loss, due to micro-bending, when put into a cable structure where it either is exposed to mechanical strain in the application or there are additional coatings put over the polyimide.

### SUMMARY

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

A first embodiment of the fiber optic cable includes an innermost fiber layer with at least one fiber, a first coating layer covering the innermost fiber layer, a second coating layer covering the first coating layer, and a third coating layer covering the second coating layer, where the second coating layer is a glass matrix layer including resin and at least one of glass filaments, yarns and rovings, and the third coating layer is a high temperature plastic layer.

According to another embodiment, the first coating layer includes at least one of silicone (Si) and Perfluoroalkoxy (PFA).

According to another embodiment, the high temperature plastic layer includes high temperature polymer.

According to another embodiment, the high temperature plastic layer includes high temperature fluoropolymer.

According to another embodiment, the high temperature plastic layer includes at least one of Perfluoroalkoxy (PFA), Polyether ether ketone (PEEK) and Perfluoroalkoxy (methyl vinyl ether (MFA)).

According to another embodiment, the innermost fiber layer includes more than one fiber.

According to another embodiment, the resin in the glass matrix layer acts as a strength member of the fiber optic cable by binding the at least one of glass filaments, yarns and rovings together.

According to another embodiment, the first coating layer, second coating layer and the third coating layers are applied in a round structure.

According to another embodiment, the first coating layer includes at least one of silicone (Si) and a high temperature plastic.

### BRIEF DESCRIPTION OF THE DRAWING

FIG. 1 is a cross-sectional view depicting different components of the RF compliant optical cable that can be used in optical sensing according to an exemplary embodiment

FIG. 2 depicts a table reciting the outer diameter, inner diameter and the tolerance of the different components of the RF compliant DTS optical cable that can be used in optical sensing according to an exemplary embodiment.

FIGS. 3-6 depict cross-sectional views of the fiber option cable according to an exemplary embodiment of the invention.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

The terms used in the description are intended to describe embodiments only, and shall by no means be restrictive. Unless clearly used otherwise, expressions in a singular from include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

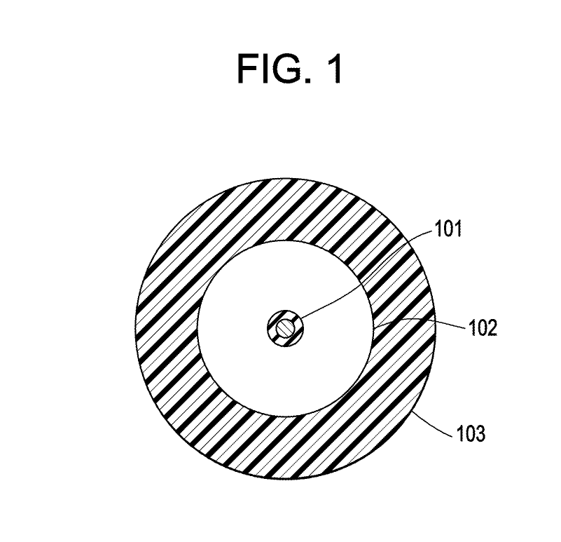

Referring to the drawings, FIG. 1 is a cross-sectional view of the high temperature RF resistant cable, depicting the different components, according to an exemplary embodiment.

The cable is designed with dielectric elements which have minimal response to RF (radio frequency) energy. A fiber, deployed in the center of the cable, is covered with suitable coatings to achieve the target temperature.

FIG. 1 shows an exemplary embodiment of a RF compliant optical cable, that can be used in optical sensing, with optical fiber that has high temperature coatings and a glass chemistry that minimizes the impact of hydrogen darkening. In certain environments, such as oil and gas wells, free hydrogen exists and those knowledgeable in this area will understand that standard glass chemistry optical fibers will show increased attenuation over time making the use of the optical fiber difficult if not impossible.

A layer of resin and glass filaments/yarns/rovings are applied over the fiber, typically in a round structure, and is cured (depending on the resin this could be cured with UV light and/or thermally cured). Known conventional methods are used to apply the layer and cure it. This layer provides protection and strength to the optical fiber. The amount of glass can be adjusted accordingly to achieve the desired tensile, elongation, crush, impact, bend, etc. performance characteristics.

The resin is used to bind the structure together to make it “rod” like. It is a variant of fiber reinforced plastic (FRP) in the telecommunications cable industry. FRP is often used as a strength member in cable structures. The uniqueness in this design is the selection of a higher temperature capable resin (>85 ° C.) that has minimal response to RF energy. The resin used in this embodiment has been thermally tested to >250° C. with minimal change in properties.

Looking at FIG. 1, we see that the innermost component of the cable is the fiber which is coated with silicone (Si) and Perfluoroalkoxy (PFA) 101, according to an exemplary embodiment. Instead of PFA, a high temperature plastic may be used, as discussed below in reference to layer 103. The middle layer comprises a glass matrix fiber rod capable of withstanding temperatures up to 200 degree Celsius (° C.) 102.

To enhance the structure further, a high temperature plastic layer may be used on top of the resin/glass covered optical fiber. For the purposes of this invention, a high temperature plastic layer comprises a plastic that is capable of withstanding a temperature of at least 85° C. The high temperature plastic layer may comprise a high temperature polymer or a high temperature fluoropolymer, such as PFA, PEEK (Polyether ether ketone), MFA (perfluoroalkoxy (methyl vinyl ether)), etc. Known conventional methods are used to create the high temperature plastic layer. According to the exemplary embodiment as shown in FIG. 1, a PFA jacket layer 103 is used which can withstand temperatures up to 250° C. and has minimal response to RF energy, according to an exemplary embodiment. Other PFA with a higher or lower temperature resistance can be used as well. Another benefit of using PFA is its low friction, making deployment of the cables easier. Furthermore, PFA is chemically resistant which allows for its use in harsh environments.

The outermost layer 103, according to the exemplary embodiment of FIG. 1, is a layer of PFA capable of withstanding a temperature of 250° C.

Another benefit of choosing a polymer to cover the resin/glass structure is to protect this structure from oxidation at high temperatures. In the presence of oxygen at high temperatures, materials like the resin, will oxidize and begin to lose their mechanical properties possibly compromising the performance of the cable.

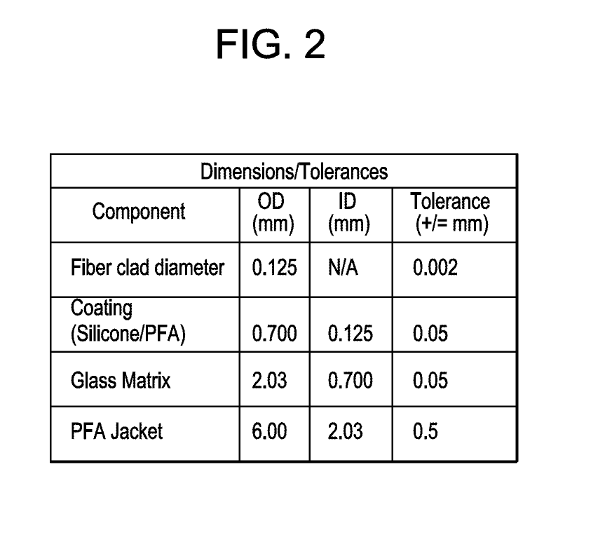

FIG. 2 depicts a table reciting the outer diameter, inner diameter and the tolerance of the different components of the RF compliant DTS cable according to the exemplary embodiment of FIG. 1.

A fiber clad diameter of 0.125 mm has a tolerance of 0.002 mm. The coating of Si/PFA with an outer diameter of 0.7 with a tolerance of 0.05 mm. The glass matrix layer with an outer diameter of 2.03 mm having an outer tolerance of 0.05 mm. Lastly the outermost layer of PFA jacket, as shown in FIG. 1, with an outer diameter of 6.00 mm, having an outer tolerance of 0.5 mm, according to an exemplary embodiment.

The above described structure allows for the use of more than 1 fiber in a cable. The 700 micron coated fiber, according to the exemplary embodiment of FIG. 1 and FIG. 2, can be replaced by an assembly of more than one fiber, according to another exemplary embodiment. According to an exemplary embodiment, the structure can include three fibers that are individually coated with a silicone and/or PFA, stranded together and then encased in a silicone and/or PFA layer over the assembly. Following that layer is a glass matrix layer and a high temperature plastic layer as described above, according to an exemplary embodiment. The structure size will be bigger according to this embodiment as the coated fiber core would be bigger when compared to the exemplary embodiment of FIG. 1. Using the methodology described above, fiber coatings for different temperature targets can be made by changing the composition of materials in the different layers coating the fiber and by changing the thickness of each layer. This further allows for different fiber chemistries depending on the sensing technology that is desired.

The use of different resins can help in providing different temperature characteristics or different handling characteristics as desired.

Different strength elements than glass and Different outer jacket material and thickness can be used based on the results desired.

The Cable structure described above survives in an RF field with minimal reaction with the RF field, thereby, allowing the use of the optical fibers to monitor temperature, acoustics, strain, etc.

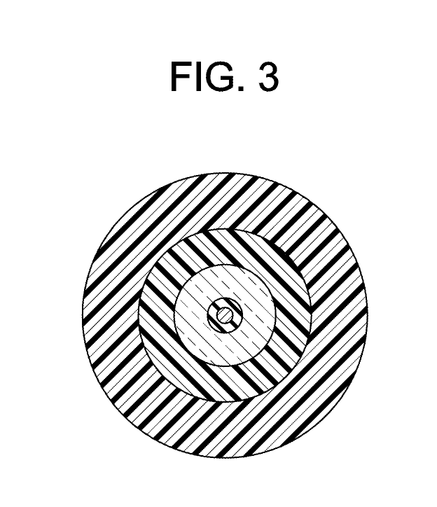

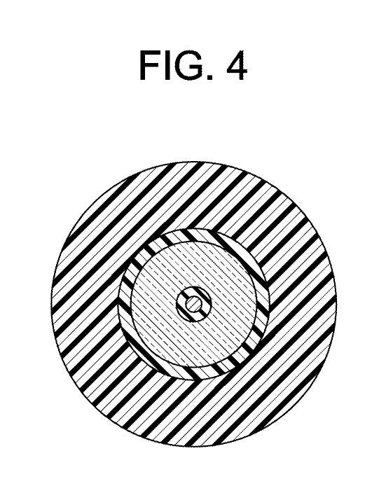

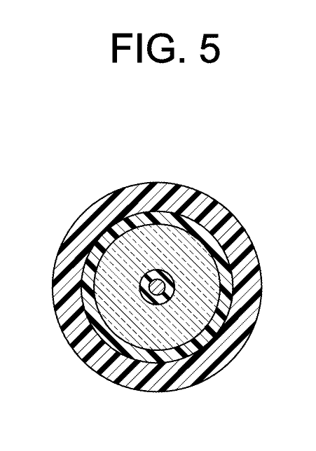

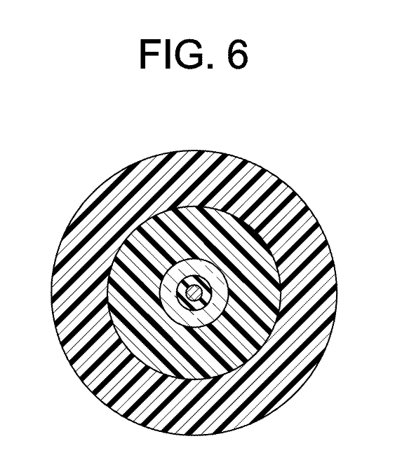

FIGS. 3-6 further depict cross-sectional views of the fiber option cable according to an exemplary embodiment of the invention.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

1. A fiber optic cable comprising:
an innermost fiber layer comprises at least one fiber;
a first coating layer covering the innermost fiber layer;
a second coating layer covering the first coating layer; and
a third coating layer covering the second coating layer, wherein
the second coating layer is a glass matrix layer comprising resin and at least one of glass filaments, yarns and rovings, and
the third coating layer is a high temperature plastic layer.

2. The fiber optic cable of claim 1, wherein
the first coating layer comprises at least one of silicone (Si) and Perfluoroalkoxy (PFA).

3. The fiber optic cable of claim 1, wherein
the high temperature plastic layer comprises a high temperature polymer.

4. The fiber optic cable of claim 1, wherein
the high temperature plastic layer comprises a high temperature fluoropolymer.

5. The fiber optic cable of claim 1, wherein
the high temperature plastic layer comprises at least one of Perfluoroalkoxy (PFA), Polyether ether ketone (PEEK) and Perfluoroalkoxy (methyl vinyl ether (MFA)).

6. The fiber optic cable of claim 1, wherein
the innermost fiber layer comprises more than one fiber.

7. The fiber optic cable of claim 1, wherein
the resin in the Mass matrix layer acts as a strength member of the fiber optic cable by binding the at least one of glass filaments, yarns and rovings together.

8. The fiber optic cable of claim 1, wherein
the first coating layer, second coating layer and the third coating layers are applied in a round structure.

9. The fiber optic cable of claim 1, wherein
the first coating layer comprises at least one of silicone (Si) and a high temperature plastic.
